(19) United States
(12) Patent Application Publication
(10) Pub. No.: US 2017/0256337 A1
(43) Pub. Date: Sep. 7, 2017

(54) HEAT-RESISTANT AND OIL-RESISTANT INSULATED ELECTRIC WIRE

(71) Applicant: YAZAKI CORPORATION, Tokyo (JP)

(72) Inventor: Satoshi Yamano, Shizuoka (JP)

(21) Appl. No.: 15/428,366

(22) Filed: Feb. 9, 2017

(30) Foreign Application Priority Data
Mar. 2, 2016 (JP) 2016-039928

(51) Int. Cl. H01B 7/29; B60R 16/02; H01B 3/30; H01B 7/282; H01B 1/02

(52) U.S. Cl. CPC H01B 7/292; H01B 7/282; H01B 1/02; H01B 3/301; B60R 16/02

(57) ABSTRACT

A heat-resistant and oil-resistant insulated electric wire is mounted on a vehicle, and includes a conductor portion and an insulator covering a periphery of the conductor portion. The insulator is made of polyphenylene sulfide resin. The conductor portion includes a twisted wire formed by twisting a plurality of element wires. At least a part of the plurality of element wires includes a plated fiber. The plated fiber is formed of a high-strength fiber and metal plating surrounding a periphery of the high-strength fiber.

### CROSS-REFERENCE TO RELATED APPLICATION(S)

This application is based on and claims priority from Japanese Patent Application (Application No. 2016-039928) filed on Mar. 2, 2016, the entire contents of which are incorporated herein by reference.

### BACKGROUND

1. Field of the Invention

The present invention relates to a heat-resistant and oil-resistant insulated electric wire.

2. Description of Related Art

An insulated electric wire has been proposed that is excellent in ATF (automatic transmission fluid) resistance property. In such an electric wire, oil resistance and heat resistance are secured by using fluororesin or a silicone rubber-based material for the insulating material that covers the conductor (see JP-A-2009-272100 and JP-A-2011-144285).

### SUMMARY

In the above-described heat-resistant and oil-resistant insulated electric wire, since it is mounted on a vehicle, there are cases where vehicular vibrations are applied while the insulator of the electric wire is in contact with another part, so that wear of the insulator sometimes occurs. In particular, since neither the fluororesin nor the silicone rubber-based material is excellent in wear resistance, it is typical that the heat-resistant and oil-resistant insulated electric wire is covered with a protecting material. However, in this case, the protecting material is indispensable. For this reason, it is desirable that the heat-resistant and oil-resistant insulated electric wire be high in wear resistance.

Moreover, when the conductor of the heat-resistant and oil-resistant insulated electric wire is a twisted wire formed by twisting a plurality of element wires, there are cases where the element wires break due to a bend or the like by vehicular vibrations. For this reason, there is also a possibility that the conductor resistance value is increased to a value not satisfying a target value if the heat-resistant and oil-resistant insulated electric wire is used for a certain period of time. Therefore, it is also desirable that the heat-resistant and oil-resistant insulated electric wire be high in bending resistance.

As described above, since the heat-resistant and oil-resistant insulated electric wire mounted on a vehicle is placed in a vibrating environment, it is desirable for it to have a structure where wear resistance and bending resistance are simultaneously improved and these properties are simultaneously satisfied.

The present invention is made to solve such a conventional problem, and an object of the invention is to provide a heat-resistant and oil-resistant insulated electric wire capable of simultaneously improving wear resistance and bending resistance.

A heat-resistant and oil-resistant insulated electric wire according to an aspect of the present invention is a heat-resistant and oil-resistant insulated electric wire mounted on a vehicle, including: a conductor portion; and an insulator covering a periphery of the conductor portion, wherein the insulator is made of polyphenylene sulfide resin, wherein the conductor portion includes a twisted wire formed by twisting a plurality of element wires, and wherein at least a part of the plurality of element wires includes a plated fiber formed of a high-strength fiber and metal plating surrounding a periphery of the high-strength fiber.

According to the heat-resistant and oil-resistant insulated electric wire of the aspect of the present invention, since the insulator is made of polyphenylene sulfide resin, wear resistance can be improved while heat resistance and oil resistance are satisfied. Moreover, since at least a part of the plurality of element wires forming the conductor portion includes the plated fiber which is the high-strength fiber plated with a metal, the plated fiber is difficult to break because of the high-strength fibers, so that the increase in conductor resistance value can be suppressed. Consequently, in the heat-resistant and oil-resistant insulated electric wire mounted on a vehicle and affected by vehicular vibrations, wear resistance and bending resistance can be simultaneously improved.

Moreover, in the heat-resistant and oil-resistant insulated electric wire according to the aspect of the present invention, at least a part of the plurality of element wires may be the plated fiber, and a remainder of the plurality of element wires may be a metal wire consisting essentially of one or more kinds of metals and having a conductivity higher than that of the plated fiber.

According to this heat-resistant and oil-resistant insulated electric wire, since a part of the plurality of element wires includes the plated fiber and a remainder thereof includes the metal wire consisting essentially of one or more kinds of metals and having a higher conductivity than the plated fiber, the overall conductivity of the conductor portion can be increased by the metal wire having a higher conductivity than the plated fiber while bending resistance is improved by the plated fiber.

Moreover, in the heat-resistant and oil-resistant insulated electric wire according to the aspect of the present invention, the plated fiber may be provided on an inner layer side of the conductor portion and the metal wire may be provided on an outer layer side of the conductor portion so as to surround a periphery of the plated fiber.

According to this heat-resistant and oil-resistant insulated electric wire, since the plated fiber is provided on the inner layer side of the conductor portion and the metal wire is provided on the outer layer side of the conductor portion so as to surround the periphery of the plated fiber, the possibility that the plated fiber breaks because of excessive deformation is further reduced by situating the plated fiber not on the inner side of bending where deformation is large with respect to bending but on the central side, so that the possibility that the conductivity resistance value of not less than a certain degree increases can be further reduced.

According to aspects of the present invention, a heat-resistant and oil-resistant insulated electric wire capable of simultaneously improving wear resistance and bending resistance can be provided.

### BRIEF DESCRIPTION OF THE DRAWINGS

FIG. 1 is a cross-sectional view showing a heat-resistant and oil-resistant insulated electric wire according to an embodiment of the present invention.

FIG. 2 is a graph showing the number of times of bending of a conductor portion and the rate of change of the conductor resistance.

FIG. 3 is a view showing details of a scrape test.

FIG. 4 is a view showing results of the scrape test.

FIG. 5 is a view showing details of the bending test.

### DETAILED DESCRIPTION

Hereinafter, an embodiment of the present invention will be described based on the drawings. The present invention is not limited to the embodiment shown below and may be modified as appropriate without departing from the scope of the present invention. Moreover, while there are parts where illustrations and descriptions of some components are omitted in the embodiment shown below, it is to be noted that regarding details of the omitted technologies, publicly known or well-known technologies are applied as appropriate within the bounds of not being inconsistent with the contents described below.

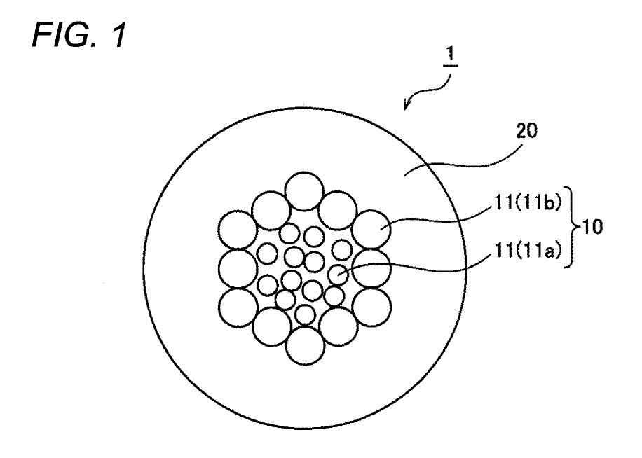

FIG. 1 is a cross-sectional view showing a heat-resistant and oil-resistant insulated electric wire according to the embodiment of the present invention. The heat-resistant and oil-resistant insulated electric wire 1 according to the present embodiment is an electric wire mounted on a vehicle and used in an environment where it can be exposed to ATF, and is formed of, as shown in FIG. 1, a conductor portion 10 and an insulator 20 covering the periphery of the conductor portion 10.

In the present embodiment, the insulator 20 is made of polyphenylene sulfide resin (PPS resin). Moreover, the conductor portion 10 is formed by twisting a plurality of element wires 11. Of the plurality of element wires 11, some are plated fibers 11a and the remainder are metal wires 11b.

The plated fibers 11a are formed of high-strength fibers such as aramid fibers, polyarylate fibers or PBO fibers and metal plating (for example, copper plating) covering the periphery of the high-strength fibers, and are formed, for example, by applying an electroless plating treatment on the high-strength fibers.

The metal wires 11b are made of (consist essentially of) only one or more kinds of metals so as to have a higher conductivity than the plated fibers 11a, and in the present embodiment, they are tinned annealed copper wires where the annealed copper wires are plated with tin so as to be made of only two kinds of metals. The metal wires 11b are not limited thereto, and may be copper element wires or the like made of only a copper material or may be wires plated with a metal other than tin. Moreover, the object to be plated is not limited to annealed copper and may be a different kind of metal such as aluminum.

Further, as shown in FIG. 1, the plated fibers 11a are twisted together and provided on the inner layer side of the conductor portion 10. On the other hand, the metal wires 11b are concentrically twisted so as to surround the periphery of the plated fibers 11a and are provided on the outer layer side of the conductor portion 10. As described above, the conductor portion 10 of the heat-resistant and oil-resistant insulated electric wire 1 according to the present embodiment has a two-layer structure. While the two-layer structure is adopted in the present embodiment, a three or more-layer structure may be adopted using plated fibers 11a of different kinds, metal wires 11b of different kinds or the like.

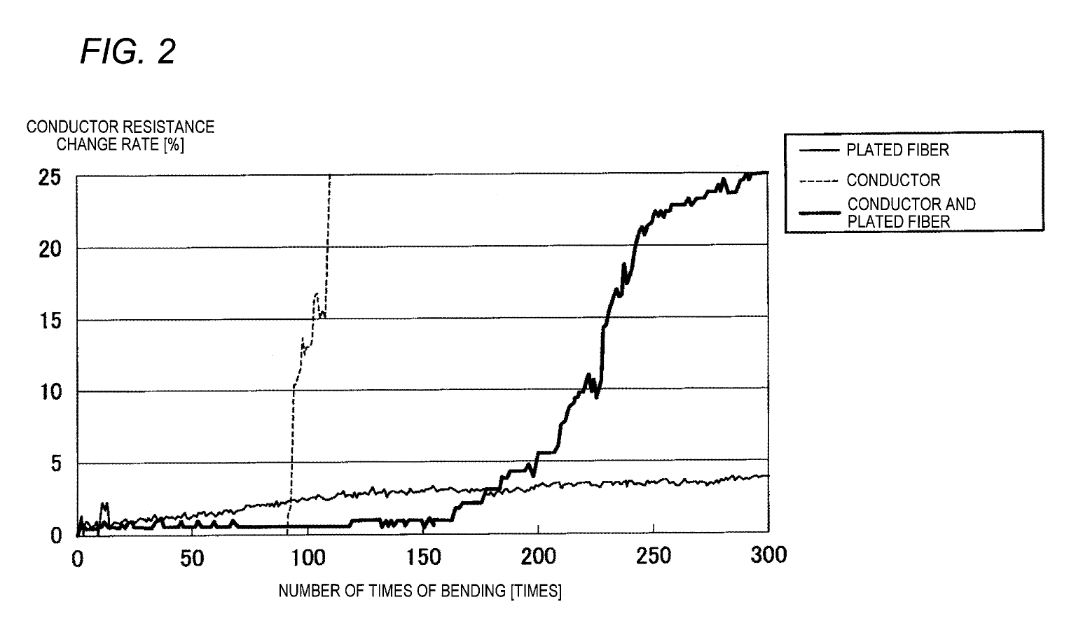

Next, the action and the like of the heat-resistant and oil-resistant insulated electric wire 1 according to the present embodiment will be described. FIG. 2 is a graph showing the number of times of bending of the conductor portion and the rate of change of the conductor resistance. As shown in FIG. 2, first, when pure copper is used for the conductor portion, the conductor resistance value after nearly 100 times of bending increases by not less than 10% compared with the resistance value before the bending. Here, if the conductor resistance value increases by 10%, it deviates from the target value and in many cases, the product specification is not satisfied. That is, when the conductor portion is pure copper, the product specification becomes unsatisfied by nearly 100 times of bending.

On the contrary, for the conductor portion 10 where the inner layer is the plated fibers 11a and the outer layer is the metal wires 11b as in the present embodiment, the number of times of bending where the conductor resistance value increases by 10% is 200 times. For this reason, it can be said that bending resistance is improved by the use of the conductor portion 10 of the present embodiment.

The conductor portion 10 may be provided with not the two-layer structure but a single-layer structure having only the plated fibers 11a. In this case, the number of times of bending where the conductor resistance value of the conductor portion 10 increases by 10% exceeds 300 times. For this reason, by providing the conductor portion 10 with a single-layer structure having only plated fibers 11a, the bending resistance can be further improved. The number of times of bending also exceeds 300 times as in the above when the conductor portion 10 is not provided with a two or more layer structure, one or several metal wires 11b are used, the remainder are only the plated fibers 11a and these are twisted together.

Next, an example according to the present invention and comparative examples will be described.

First, the heat-resistant and oil-resistant insulated electric wire according to the example had a conductor portion such that 80 plated fibers (polyarylate fibers [Vectran (trademark) manufactured by Kuraray (trademark)] plated with copper) with a diameter of 22 μm were twisted into the inner layer and 18 metal wires (tinned annealed copper wires) were provided as the outer layer by being twisted on the inner layer. At this time, the conductor cross-sectional area was 0.3701 mm² and the outside diameter was 0.72 mm.

For the insulator, PPS resin was used, and the material thickness thereof was 0.25 mm. The finishing outside diameter of this heat-resistant and oil-resistant insulated electric wire was 1.22 mm. The conductor resistance value was 50.8 mΩ/m at 20 degrees C. and the mass was 3.28 g/m.

For the heat-resistant and oil-resistant insulated electric wire according to a first comparative example, an electric wire of item number ARX-9 manufactured by Sumitomo Electric Industries, Ltd. (trademark) was used. The conductor portion of this electric wire was formed by twisting 19 tinned annealed copper wires with a diameter of 0.18 mm, the conductor cross-sectional area was 0.54 mm², and the outside diameter was approximately 0.95 mm. For the insulator, fluororubber was used, and the thickness (material thickness) was 0.30 mm in the part where the thickness was minimum, and was 0.38 mm in the standard part. The finishing outside diameter of this heat-resistant and oil-resistant insulated electric wire was 1.7 mm, and even the maximum finishing outside diameter including the tolerance was 1.82 mm. The conductor resistance was 38.7 mΩ/m at 20 degrees C. and the mass was 8.0 g/m.

Moreover, for the heat-resistant and oil-resistant insulated electric wire according to a second comparative example, an electric wire of item SEA-2 manufactured by Nissei Electric Co., Ltd. was used. The conductor portion of this electric wire was formed by twisting 19 tinned annealed copper wires with a diameter of 0.18 mm, the conductor cross-sectional area was 0.5387 mm², and the outside diameter was approximately 0.95 mm. For the insulator, fluororesin was used, and the thickness (material thickness) was 0.20 mm in the part where the thickness was minimum and 0.25 mm in the standard part. The finishing outside diameter of this heat-resistant and oil-resistant insulated electric wire was 1.45 mm, and even the maximum finishing outside diameter including the tolerance was 1.55 mm. The conductor resistance was 38.7 mΩ/m at 20 degrees C. and the mass was 6.0 g/m.

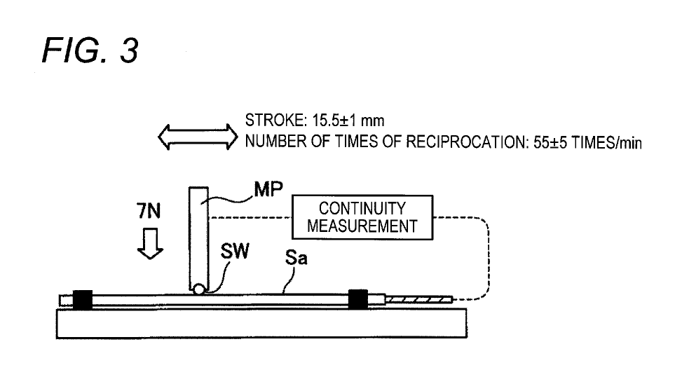

On the heat-resistant and oil-resistant insulated electric wires according to the example and first and second comparative examples described above, a scrape test conforming to ISO6722 was performed. FIG. 3 is a view showing details of the scrape test. As shown in FIG. 3, in the scrape test, first, the electric wire as a sample Sa was supported and fixed. Then, the tip of a metal plunger MP to the tip of which a spring wire (hard drawn copper wire) SW of φ0.45 mm was attached was pressed against the sample Sa with a load of 7 N, and the metal plunger MP was operated in the direction of the length of the sample Sa under a condition where the stroke was 15.5±1 mm and the number of times of reciprocation was 55±5 times/min. Then, the number of times of reciprocation until continuity is established between the metal plunger MP and the conductor portion of the sample Sa was measured.

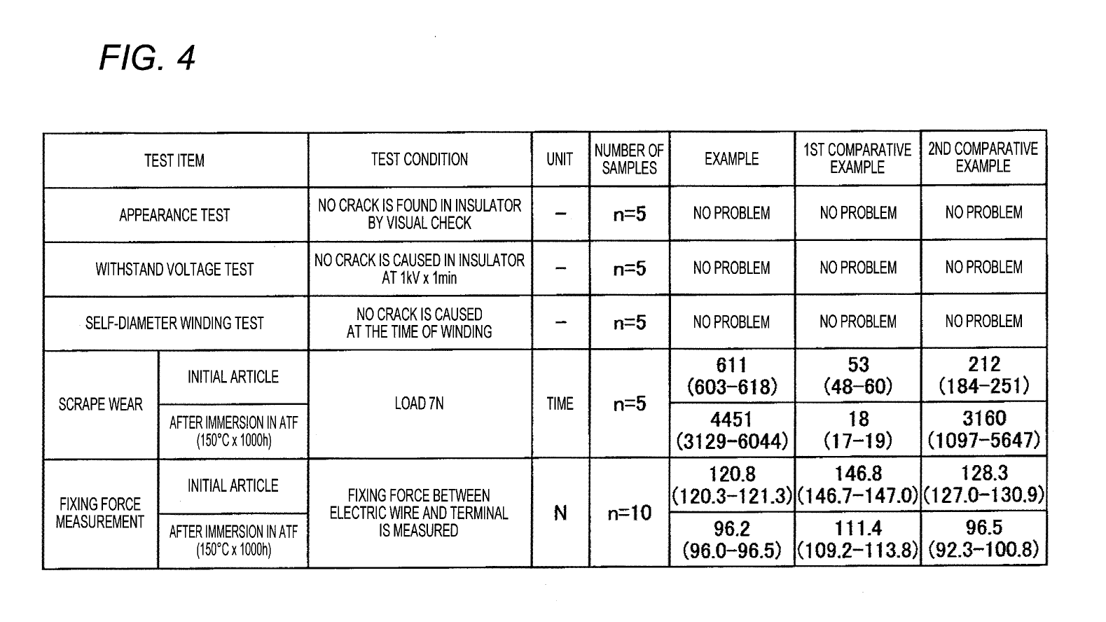

FIG. 4 is a view showing results of the scrape test. As shown in FIG. 4, the scrape test was performed on two objects: a sample Sa which is an initial article and a sample Sa immersed in ATF of 150 degrees C. and left for 1000 hours. In FIG. 4, in addition of the scrape test, a fixing force measurement test was also performed on the two samples Sa. Further, on the latter of the two samples Sa, an appearance test, a withstand voltage test and a self-diameter winding test were also performed.

As shown in FIG. 4, in the scrape test, the number of samples was “5”. Regarding the initial article sample Sa of the example, the number of times of reciprocation until the establishment of continuity was 603 times to 618 times, and the median value was 611 times. Regarding the sample Sa after immersion of the example, the number of times of reciprocation until the establishment of continuity was 3129 times to 6044 times, and the median value was 4451 times.

Regarding the initial article sample Sa of the first comparative example, the number of times of reciprocation until the establishment of continuity was 48 times to 60 times, and the median value was 53 times. Regarding the sample Sa after immersion of the first comparative example, the number of times of reciprocation until the establishment of continuity was 17 times to 19 times, and the median value was 18 times.

Regarding the initial article sample Sa of the second comparative example, the number of times of reciprocation until the establishment of continuity was 184 times to 251 times, and the median value was 212 times. Regarding the sample Sa after immersion of the second comparative example, the number of times of reciprocation until the establishment of continuity was 1097 times to 5647 times, and the median value was 3160 times.

As described above, it was found that since the PPS resin was used as the insulator in the example, wear resistance was improved compared with when fluororesin or fluororubber was used.

In the fixing force test, the number of samples was “10”. In the fixing force test, the load (N) when the terminal of the electric wire to which the terminal was crimped and the electric wire were pulled from each other and the terminal was detached was measured. As the terminal, terminals all having the same structure and having different sizes were adopted in the example and the first and second comparative examples. The sizes conformed to the ratios of the conductor cross-sectional areas of the example and the first and second comparative examples, respectively, and the terminals were performed in such a manner that the crimp height ratios were the same. The crimp height ratio is the ratio of the height after crimping to the diameter (height) of the conductor portion.

Regarding the initial article sample Sa of the example, the terminal fixing force was 120.3 N to 121.3 N, and the median value was 120.8 N. Regarding the sample Sa after immersion of the example, the terminal fixing force was 96.0 N to 96.5 N, and the median value was 96.2 N.

Regarding the initial article sample Sa of the first comparative example, the terminal fixing force was 146.7 N to 147.0 N, and the median value was 146.8 N. Regarding the sample Sa after immersion of the first comparative example, the terminal fixing force was 109.2 N to 113.8 N, and the median value was 111.4 N.

Regarding the initial article sample Sa of the second comparative example, the terminal fixing force was 127.0 N to 130.9 N, and the median value was 128.3 N. Regarding the sample Sa after immersion of the second comparative example, the terminal fixing force was 92.3 N to 100.8 N, and the median value was 96.5 N.

As described above, it was found that in the heat-resistant and oil-resistant insulated electric wire according to the example, a terminal fixing force equal to those of the first and second comparative examples can be obtained.

In the appearance test, the withstand voltage test and the self-diameter winding test, the number of samples was “5”. In the appearance test, it was visually checked whether there was a crack in the insulator or not, in the withstand voltage test, it was checked whether a crack was caused in the insulator by voltage application of 1 kV×1 min or not, and in the self-diameter winding test, it was checked whether there was a crack in the insulator at the time of winding or not.

As a result of these tests, it was confirmed that there was no crack in any of the example and the first and second comparative examples.

As described above, it was found that the heat-resistant and oil-resistant insulated electric wire according to the example had an ATF resistance equal to those of the first and second comparative examples (it was found that it was excellent in heat resistance and oil resistance).

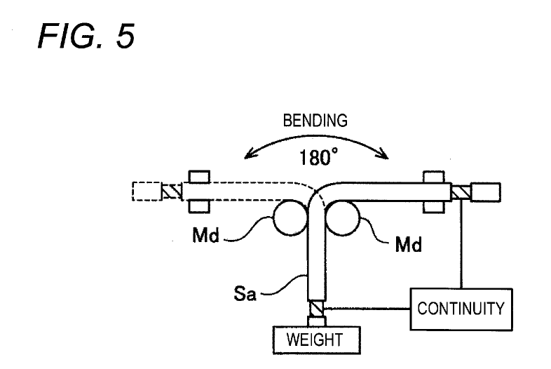

Further, a bending test was performed on the heat-resistant and oil-resistant insulated electric wires according to the example and the first and second comparative examples. FIG. 5 is a view showing details of the bending test. As shown in FIG. 5, the sample Sa, one end of which was held and to the other end of which a weight of 400 g was attached, was bent by 180° with respect to a mandrel Md of φ25 mm. It was bent in both ways 30 times per minute, and the number of times of reciprocation until the conductor resistance value increases by 10% was measured. The environmental temperatures at the time of the measurement were a room temperature (20 degrees C.) and a low temperature (−30 degrees C.). Further, the number of samples was “10”.

In the room temperature environment, the number of times of bending of the sample Sa of the example was 11720 times to 13030 times, and the median value was 12404 times. The number of times of bending of the sample Sa of the first comparative example was 6472 times to 7838 times, and the median value was 7177 times. The number of times of bending of the sample Sa of the second comparative example was 6312 times to 6532 times, and the median value was 6392 times.

In the low temperature environment, the number of times of bending of the sample Sa of the example was 14700 times to 16844 times, and the median value was 16019 times. The number of times of bending of the sample Sa of the second comparative example was 10112 times to 11092 times, and the median value was 10555 times.

Thus, it was found that the heat-resistant and oil-resistant insulated electric wire according to the example was more excellent in bending resistance than the heat-resistant and oil-resistant insulated electric wires according to the first and second comparative examples since it used the conductor portion including plate fibers. The numbers of times of bending shown here are different from the values of FIG. 2 since the evaluation condition is different from that of the principle test shown in FIG. 2 (the bending test shown above, and a mandrel of φ2 mm was used).

As described above, it was found from the results of the scrape test and the bending test that the heat-resistant and oil-resistant insulated electric wire according to the example can simultaneously improve wear resistance and bending resistance. Further, it was found that the ATF resistance thereof is equal to those of the first and second comparative examples.

As described above, according to the heat-resistant and oil-resistant insulated electric wire 1 of the present embodiment, since the insulator 20 is made of PPS resin, wear resistance can be improved while heat resistance and oil resistance are satisfied. Moreover, since at least some of the plurality of element wires 11 constituting the conductor portion 10 are the plated fibers 11a which are high-strength fibers plated with a metal, the plated fibers 11a are difficult to break because of the high-strength fibers, so that the increase in conductor resistance value can be suppressed. Consequently, in the heat-resistant and oil-resistant insulated electric wire 1 mounted on a vehicle and affected by vehicular vibrations, wear resistance and bending resistance can be simultaneously improved.

Moreover, since some of the plurality of element wires 11 are the plated fibers 11a and the remainder thereof are the metal wires 11b made of only one or two or more kinds of metals and having a higher conductivity than the plated fibers 11a, the overall conductivity of the conductor portion 10 can be increased by the metal wires 11b having a higher conductivity than the plated fibers 11a while bending resistance is improved by the plated fibers 11a.

Moreover, since the plated fibers 11a are provided on the inner layer side of the conductor portion 10 and the metal wires 11b are provided on the outer layer side of the conductor portion 10 so as to surround the periphery of the plated fibers 11a, the possibility that the plated fibers 11a break because of excessive deformation is further reduced by situating the plated fibers 11a not on the inner side of bending where deformation is large with respect to bending but on the central side, so that the possibility that the conductivity resistance value of not less than a certain degree increases can be further reduced.

While the present invention is described above based on the embodiment, the present invention is not limited to the above-described embodiment and may be modified without departing from the scope of the present invention.

What is claimed is:

1. A heat-resistant and oil-resistant insulated electric wire mounted on a vehicle, comprising:
a conductor portion; and
an insulator covering a periphery of the conductor portion,
wherein the insulator is made of polyphenylene sulfide resin,
wherein the conductor portion comprises a twisted wire formed by twisting a plurality of element wires, and
wherein at least a part of the plurality of element wires is a plated fiber formed of a high-strength fiber and metal plating surrounding a periphery of the high-strength fiber.

2. The heat-resistant and oil-resistant insulated electric wire according to claim 1,
wherein a part of the plurality of element wires comprises the plated fiber, and
wherein a remainder of the plurality of element wires comprises a metal wire consisting essentially of one or more kinds of metals and having a conductivity higher than that of the plated fiber.

3. The heat-resistant and oil-resistant insulated electric wire according to claim 2,
wherein the plated fiber is provided on an inner layer side of the conductor portion, and
wherein the metal wire is provided on an outer layer side of the conductor portion so as to surround a periphery of the plated fiber.
